(19) United States
(12) Patent Application Publication
(10) Pub. No.: US 2017/0210495 A1
(43) Pub. Date: Jul. 27, 2017

(54) SOLAR SPACE WASTE AND DEFENSE INCINERATION SYSTEM

(71) Applicant: JOHN D ARWOOD, JACKSONVILLE, FL (US)

(72) Inventor: JOHN D ARWOOD, JACKSONVILLE, FL (US)

(21) Appl. No.: 15/279,759

(22) Filed: Sep. 29, 2016

Related U.S. Application Data
(63) Continuation-in-part of application No. 62/287,119, filed on Jan. 26, 2016.

(51) Int. Cl. B64G 1/64; B64G 1/24

(52) U.S. Cl. CPC B64G 1/648; B64G 1/242

(57) ABSTRACT

An unmanned vehicle comprising a navigable propulsion system for moving the vehicle in an operating environment and a controllable steering mechanism for steering the vehicle as it moves in the operating environment; and a tethering mechanism for attaching to existing space debris including waste, garbage, derelict satellites and equipment, and other debris; and tethering device for attaching to waste hauling device for disposing of waste generated from inhabited orbiting structures. The propulsion device is a universal transportation device for assorted space debris utilizing connectors for hauling collected waste captured in fibrous formulated cloth material, or individual pieces of debris, or equipment. A telescoping utility arm provides the capability to direct the hook mechanism and tethering device to secure space waste and debris of various shapes, sizes, and conditions for transportation. A fibrous formulated containment device collects waste from inhabited space structures.

### CROSS REFERENCES TO RELATED APPLICATIONS

Continuation in Part of Provisional Patent 62287119 filed on 2016 Jan. 26

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of waste management. More specifically, the invention comprises a method of waste removal and disposal for orbiting debris, waste, junk, garbage, and derelict equipment by means of solar incineration.

2. Description of the Related Art

The invention would consist of 3 parts: debris item(s) capture, tethering attachment, and transport of item(s). Displayed in FIG. 1, the device would maneuvering to match the orbit of an existing space waste item and attaching the tethering cable. This would consist of mechanically attaching a tethering cable between the captured waste item(s) and a small propulsion system used to escape Earth's orbit and provide for course corrections on a trajectory to the Sun. FIG. 2a displays the small propulsion system used to transport the tethered waste item(s), on a trajectory to the Sun for incineration. FIG. 2b displays the antenna used for onboard basic communications and navigation systems. FIG. 3 displays how the device would be used to capture the space waste item(s) by filling a strong fibrous formulated cloth material in an inhabited structure, such as an orbiting space station.

The primary use of the invention would consist of the black fibrous formulated cloth material being filled with waste item(s) from a structure, such as a space station or other inhabited orbiting structure. The invention would then be ejected from the structure with the small propulsion system already tethered for transport to the Sun for incineration. The secondary use of the invention would consist of the orbiting space debris item(s) being tethered by mechanical attachment, after matching orbital trajectories, to the small propulsion system so they can be towed to the Sun for incineration.

### BRIEF SUMMARY OF THE PRESENT INVENTION

There are numerous man made objects currently orbiting the Earth. Many of these objects are classified as junk, garbage, or trash such as decommissioned, derelict, or non-functioning satellites, used rocket boosters, or debris from past space exploration efforts. These objects are already causing problems for existing satellites operating in Earth's orbit and will continue to be a problem for new satellites, as well as for future governmental and commercial spaceflight operations.

The related art portrays the invention as a means of managing waste from orbiting inhabited structures to prevent adding to the problem of orbiting space garbage. The related art also shows a second application for the invention by collecting a non-functioning satellite before towing it to the Sun for solar incineration. The Sun is 93 million miles from the Earth. At a distance of approximately 1.1 million miles from the Sun, the invention and its entire cargo would be incinerated by the Sun's heat. The fibrous formulated cloth material, portrayed in the primary use, will be black in color to promote heating and incineration.

Incineration is a proven method of waste management and disposal on Earth. This method is used for both hazardous and non-hazardous waste, junk, and garbage. There are also proven methods of unmanned cargo transportation in space. This invention provides a unique and sophisticated method of preventing future space waste and capturing orbiting space items, junk, and garbage. The invention then provides for the transporting and mitigating of that waste through solar incineration. This level of sophistication has not yet been applied to the management of orbiting space waste. The present invention seeks to provide such a sophisticated method of space waste removal and disposal.

### BRIEF DESCRIPTION OF DRAWINGS

FIG. 1 shows the invention utilizing a telescoping utility arm equipped with a tethering cable and hook apparatus to collect large orbiting space debris.

FIGS. 2a and 2b show a more detailed view of the Small Propulsion System with a top and bottom view.

FIG. 3 shows the present invention being used as a means of managing waste from an inhabited orbiting space structure.

### DETAILED DESCRIPTION OF THE INVENTION

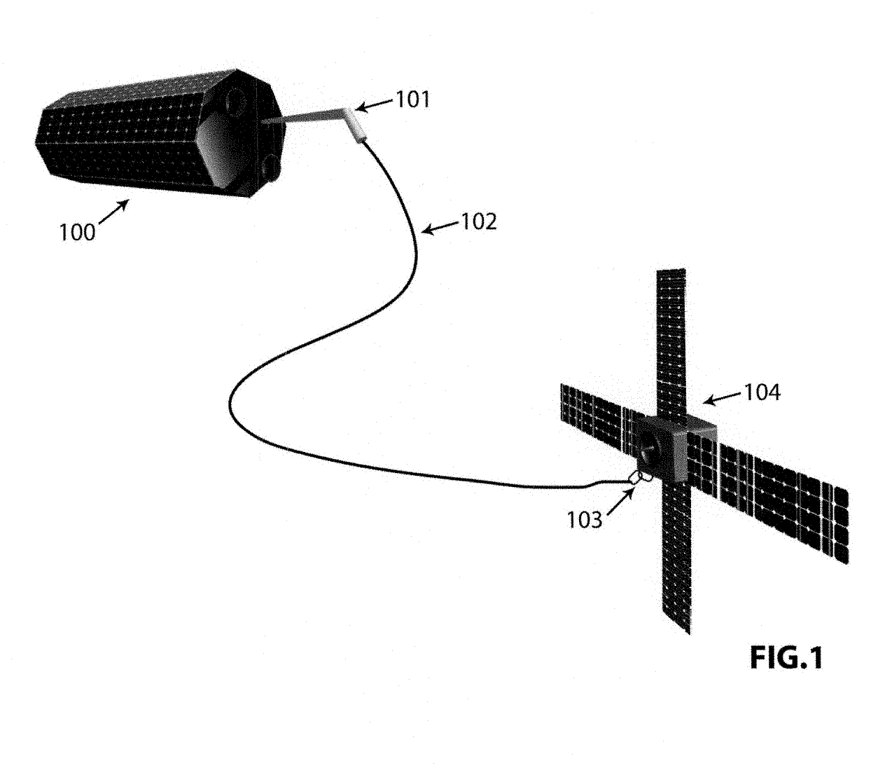

FIG. 1

The purpose of FIG. 1 is to show the invention utilizing a telescoping utility arm equipped with a tethering cable and hook apparatus to collect large orbiting space debris (e.g. a decommissioned satellite) for transport towards the Sun for incineration.

Elements of FIG. 1.

100. Small Propulsion System attached to large space debris

101. Telescoping Utility Arm

102. Tethering Cable

103. Hook

104. Large Space Debris

FIG. 1 shows the tethering cable mechanically attached to the small propulsion system. This cable would have the necessary strength to withstand the force of gravitational pull on the waste item in the weightless space environment. This system could also be jettisoned from an existing space station or orbiting structure in it's fully connected state.

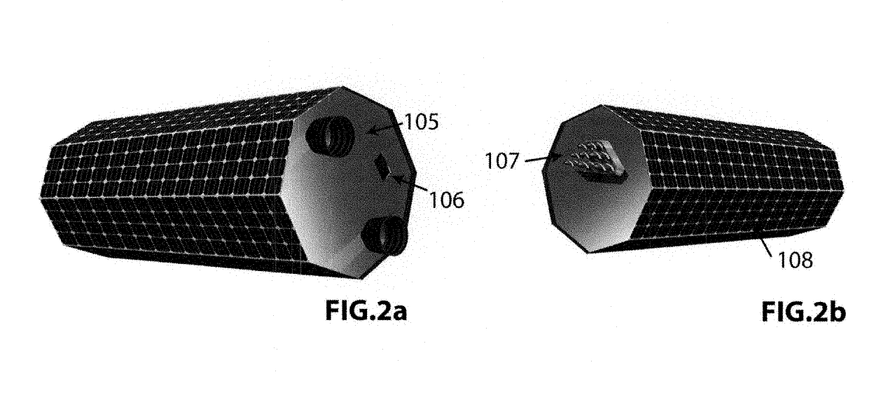

FIGS. 2a and 2b

The purpose of FIGS. 2a and 2b are to show a more detailed view of the Small Propulsion System with a top and bottom view. The bottom view in FIG. 2b shows the dual thrusters used for course corrections and opening for the telescoping utility arm. The top view in FIG. 2b shows the antenna for the onboard basic communications and navigation systems. FIGS. 2a and 2b also show solar panels used for powering the onboard basic communications and navigation systems.

Elements of FIG. 2a.
105. Thrusters
106. Telescoping Utility Arm opening

Elements of FIG. 2b.
107. Antenna
108. Solar Panels

FIG. 2a shows the small propulsion system. This is a simple dual thruster propellant powered vehicle with a tethering cable that can be mechanically attached to a space waste item. The small propulsion system would contain an onboard basic communications and navigation system used for course corrections from controllers on Earth. The antenna displayed in FIG. 2b would be used to facilitate these communications. The onboard systems would be powered by a solar electric battery providing enough power to escape Earth's orbit, set a trajectory towards the Sun, and provide for course correction as needed.

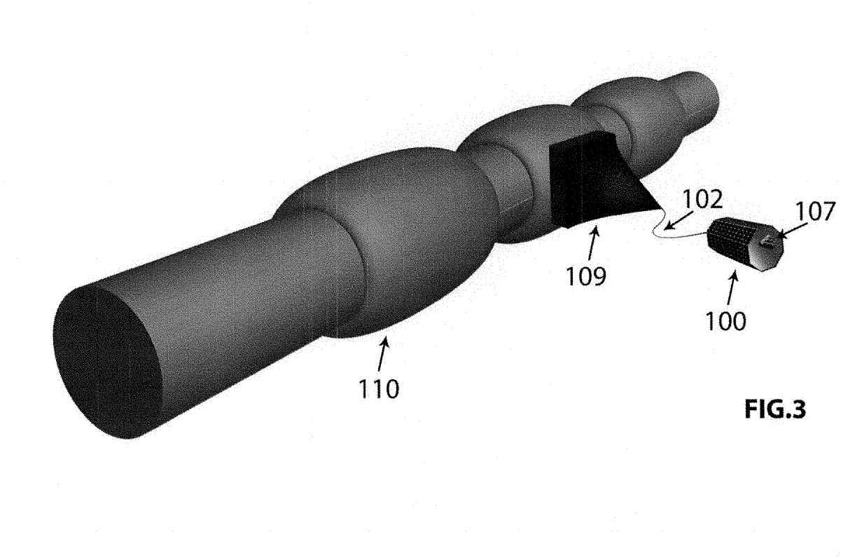

FIG. 3

The purpose of FIG. 3 is to show the invention connected with it's tethering cable to the strong fibrous formulated cloth bag in order to collect and store waste from an inhabited orbiting space structure. After reaching capacity, the invention with tethered waste bag would close and pull away from the structure on a course for proper destruction of waste through solar incineration.

Elements of FIG. 3.

100. Small Propulsion System pulling bag away from orbiting space structure

102. Tethering Cable

107. Antenna

109. Space Waste Bag attached to orbiting space structure

110. Orbiting Inhabited Space Structure

FIG. 3 shows the present invention being used as a means of managing waste from an inhabited orbiting space structure. In this application, the invention would be ejected from the orbiting structure with the small propulsion system already tethered to the strong, black, tear-resistant, fibrous formulated cloth material that could be closed at one end with an embedded cable and containing waste and garbage generated from within the structure. As a secondary usage the invention would match the orbit of a larger existing space waste item so it can be tethered and towed as described in FIG. 3. This application would be accomplished by using the invention's propulsion system and navigation system along with existing technologies to launch and rendezvous the invention with the waste item.

The invention claimed is:

1. A unmanned vehicle comprising: remote navigable propulsion system, controllable steering mechanism, and tethering device.

2. Invention of claim 1 further comprising: strong, black, tear-resistant, fibrous formulated cloth material that could be closed at one end with an embedded cable for containing waste generated from within inhabited space structure.

3. Invention of claim 2 hauls load to escape Earth's orbit and adjust trajectory towards Sun for incineration.

4. Invention of claim 1 further comprising: device propulsion system and navigation system matching the orbit of existing space debris item so it can be tethered and towed for disposal.

5. Invention of claim 4 hauls load to escape Earth's orbit and adjust trajectory towards Sun for incineration.
